(19) United States
(12) Patent Application Publication
(10) Pub. No.: US 2022/0413635 A1
(43) Pub. Date: Dec. 29, 2022

(54) STYLUS DEVICE ATTACHMENTS

(71) Applicant: HEWLETT-PACKARD DEVELOPMENT COMPANY, L.P., Spring, TX (US)

(72) Inventors: Kun-Hung Lin, Taipei (TW); Hao Ming Chen, Taipei (TW); Chia-Wei Ting, Taipei (TW)

(73) Assignee: HEWLETT-PACKARD DEVELOPMENT COMPANY, L.P., Spring, TX (US)

(21) Appl. No.: 17/358,185

(22) Filed: Jun. 25, 2021

(51) Int. Cl. G06F 3/0354; F16M 13/02; G06F 1/16

(52) U.S. Cl. CPC G06F 3/03545; F16M 13/02; G06F 1/1607

(57) ABSTRACT

In examples in accordance with the present disclosure, a stylus device is described. An example stylus device includes a body portion having an opening. The example stylus device also includes a retractable attachment mechanism to connect the stylus device to a receiver mechanism. The example attachment mechanism includes a magnet to cause the attachment mechanism to extend through the opening in response to a magnetic force. The example attachment mechanism also includes a bias mechanism to retract the attachment mechanism into the body portion.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a illustrates an attachment mechanism to attach a stylus device to an electronic device, according to an example.

FIG. 2 is a section view illustrating a system that includes the stylus device and the electronic device, according to an example.

FIG. 3 is a section view illustrating a system that includes the stylus device and the electronic device, according to another example.

FIGS. 4A and 4B illustrate the stylus device, according to an example.

FIGS. 5A and 5B are section views of the stylus device, according to an example.

FIG. 6 illustrates the attachment mechanism aligning a port of the stylus device with a port of the electronic device, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An electronic device may be a device that includes electronic circuitry. For instance, an electronic device may include integrated circuitry (e.g., transistors, digital logic, semiconductor technology, etc.). Examples of electronic devices include computing devices, laptop computers, desktop computers, smartphones, tablet devices, graphic tablets, multi-touch devices, wireless communication devices, game consoles, smart appliances, vehicles with electronic components, aircraft, drones, robots, smart appliances, etc.

In some examples, a stylus device may be a device to provide input to the electronic device. For example, the stylus device may have a pen-shaped end that interacts with a touch sensor (e.g., touchscreen, touchpad, etc.) of the electronic device. In some examples, a user may hold the stylus device and may press the stylus device upon a touch sensor of the electronic device to provide user input. In some examples, the stylus device may also be referred to as a stylus, stylus pen, touch pen, active pen, digital pen, etc.

In some examples, the stylus device may attach to the electronic device. In an approach, the stylus device is attached to the electronic device using multiple magnets located on both the stylus device and the exterior of the electronic device. In this approach, the magnets align to hold the stylus device in place. However, in this approach, the stylus device may be easily detached from the electronic device when an external force exceeds the magnetic force holding the stylus device. For example, when a user places the electronic device and stylus device in their backpack, the stylus device may be easily knocked free from the electronic device as the stylus device contacts the side of the backpack. In another example, when the stylus device is connected to the electronic device while a user is walking around, the stylus device may brush against the user's body and may fall to the ground.

In the present specification and figures, examples of attachment mechanisms to attach the stylus device to the electronic device are described. In some examples, the stylus device includes a body portion having an opening. The stylus device also includes a retractable attachment mechanism to connect the stylus device to a receiver mechanism. In some examples, the attachment mechanism may include a magnet to cause the attachment mechanism to extend through the opening in response to a magnetic force. In some examples, a bias mechanism may retract the attachment mechanism into the body portion.

Examples of an electronic device are also described. The electronic device includes a receiver mechanism. For example, the receiver mechanism includes a receiver opening to receive the attachment mechanism of the stylus device. The receiver mechanism also includes a receiver magnet to apply a magnetic force to the magnet of the attachment mechanism. The receiver magnet may cause the attachment mechanism to extend through an opening in the stylus device.

In some examples, a system is described. The system includes a stylus device and an electronic device. The stylus device includes a magnet to extend out of the stylus device in response to an external magnetic force. The stylus device also includes a bias mechanism to retract the magnet into the stylus device when a bias mechanism force is greater than the magnetic force. The electronic device includes a receiver opening to receive the magnet of the stylus device. The electronic device may also include a receiver magnet to apply the magnetic force to the magnet of the stylus device.

The examples described herein may prevent the improper placement of the stylus device on the electronic device. Furthermore the described examples may avoid accidental disengagement of the stylus device from the electronic device. For example, by using the described examples of the attachment device, the stylus may not be knocked loose when a user moves their backpack due to contact of the stylus device with the side of the backpack.

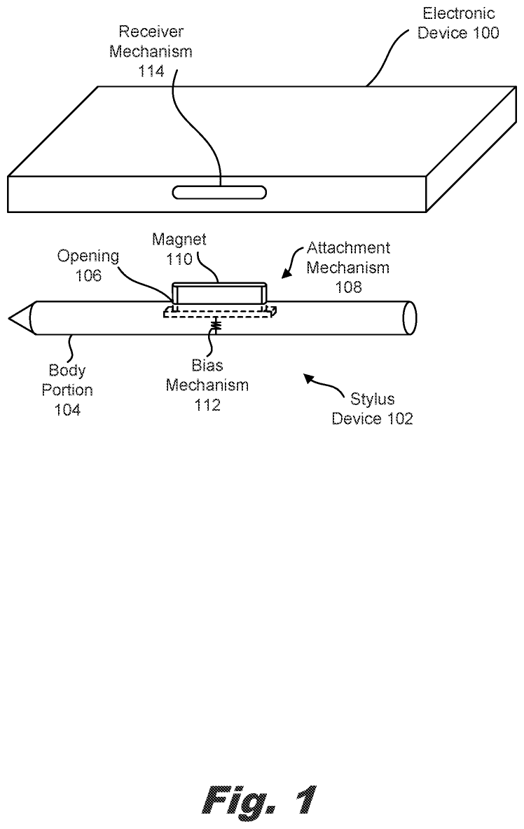

Various examples described below relate to the attachment of the stylus device to the electronic device. Turning now to the figures, FIG. 1 illustrates an attachment mechanism 108 to attach a stylus device 102 to an electronic device 100, according to an example. Examples of the electronic device 100 may include computing devices, laptop computers, desktop computers, smartphones, tablet devices, graphic tablets, multi-touch devices, keyboards, wireless communication devices, game consoles, game controllers, smart appliances, vehicles with electronic components, aircraft, drones, robots, smart appliances, etc.

In some examples, the stylus device 102 may be used to interact with the electronic device 100. For example, the stylus device 102 may be used to contact a touch sensor (e.g., touch display) of the electronic device 100. In some examples, the stylus device 102 may include a pen-like tip to contact the touch sensor of the electronic device 100. In some examples, the stylus device 102 may include electronic circuitry to interact with the electronic device 100 to perform operations on the electronic device 100. For example, the stylus device 102 may include a user interface device (e.g., a button, jog dial, etc.) to send a signal to the electronic device 100.

The stylus device 102 may include a body portion 104. As used herein, the body portion 104 may form the main shaft component of the stylus device 102. In some examples, the body portion 104 may be defined by a central axis. In some examples, the body portion 104 may be cylindrical or predominately cylindrical.

In some examples, the body portion 104 may include a cavity. For example, the body portion 104 may have an exterior sidewall that defines a hollow interior cavity. The exterior sidewall may define an exterior surface of the body portion 104.

In some examples, the body portion 104 may include an opening 106. The opening 106 is sized to allow an attachment mechanism 108 or a portion of the attachment mechanism 108 to pass through the interior cavity of the body portion 104 and project beyond the exterior surface of the body portion 104. For example, a first portion of the attachment mechanism 108 may be sized to extend through the opening 106 while a second portion of the attachment mechanism 108 remains housed within the body portion 104.

The retractable attachment mechanism 108 may connect the stylus device 102 to a receiver mechanism 114 of the electronic device 100. As used herein, the term “retractable” refers to the ability of the attachment mechanism 108 (or a portion of the attachment mechanism 108) to move in and out of the body portion 104. As used herein, the attachment mechanism 108 may include components that move in response to exerted forces (e.g., magnetic forces, bias forces, etc.). Therefore, as described herein, the term “attachment mechanism moves” may refer to movement of a component of the attachment mechanism 108. For example, while in a first position (referred to as a retracted position), a portion of the attachment mechanism 108 may be housed within the body portion 104 such that an exterior surface of the attachment mechanism 108 is aligned flush with the exterior surface of the body portion 104. When the attachment mechanism 108 is in a second position (referred to as an extended position), a portion of the attachment mechanism 108 may extend out of the body portion 104 such that the exterior surface of the attachment mechanism 108 extends beyond the exterior surface of the body portion 104.

It should be noted that the attachment mechanism 108 may move in and out of the body portion 104 in one axis. In some examples, the axis for the attachment mechanism 108 motion is perpendicular to the central axis of the body portion 104. The attachment mechanism 108 may experience translational movement within the housing of the body portion 104. This translational movement may be orthogonal movement of a portion of the attachment mechanism with respect to the length axis (i.e., central axis) of the body portion 104.

The receiver mechanism 114 may include a receiver opening to receive the attachment mechanism 108 of the stylus device 102. For example, the receiver opening may be sized to allow the attachment mechanism 108 to be inserted into the electronic device 100.

In some examples, the attachment mechanism 108 may include a magnet 110 to cause the attachment mechanism 108 to extend through the opening 106 in response to a magnetic force. For example, the receiver mechanism 114 may include a receiver magnet that interacts with the magnet 110 of the attachment mechanism 108. The receiver magnet may be housed within the receiver mechanism 114 at a distance from the receiver opening. When the magnet 110 of the attachment mechanism 108 is located at a distance less than a threshold distance of the receiver magnet, the attachment mechanism 108 may move out of the opening 106 of the stylus device 102. As used herein, a magnetic force is a force exerted on a material due to a magnetic field. The magnetic force may also be referred to as magnetic field strength. The magnet 110 of the stylus device 102 may be aligned with the receiver magnet of the receiver mechanism 114 such that magnetic fields of each magnet attract each other and pull towards each other when the attachment mechanism 108 is brought near the receiver mechanism 114.

In some examples, the magnet 110 may be a permanent magnet. In some examples, the magnet 110 may be formed from a neodymium material (e.g., n48, n50, n52, etc.) or other rare earth magnet. In some examples, the receiver magnet of the receiver mechanism 114 may also be a permanent magnet (e.g., a neodymium magnet).

In some examples, the attachment mechanism 108 may include a motion arresting element to prevent the attachment mechanism 108 from detaching from the stylus device 102. For example, the attachment mechanism 108 may include a bumper or projection that interfaces with the interior sidewall of the body portion 104 once a portion of the attachment mechanism 108 protracts a given distance out of the stylus device 102. In some examples, the motion arresting element may be integrated into the magnet 110. For example, the magnet 110 may be formed with projections that prevent the mechanism 108 from exiting the stylus device 102 when the attachment mechanism 108 is extended.

In some examples, the attachment mechanism 108 may include an interface body. This interface body may be the part of the attachment mechanism 108 that extends and retracts out of the opening 106 of the body portion 104.

In some examples, the magnet 110 may form the interface body. In other words, the magnet 110 may be the part of the attachment mechanism that extends out of the body portion 104 and is inserted into the receiver mechanism 114 of the electronic device 100.

In some examples, the attachment mechanism 108 may include an interface body that is separate from the magnet 110. For example, the magnet 110 may be housed within the attachment mechanism 108. The magnet 110 may interact with the magnetic field of the receiver magnet as described above to move the attachment mechanism 108. However, a separate interface body may be inserted into the receiver opening.

In some examples, the interface body may be sized to be inserted into the receiver opening of the receiver mechanism 114. For example, the profile of the interface body may fit within the profile of the receiver opening. In some examples, the size of the interface body profile may be less than the profile of the receiver opening such that the interface body has a clearance fit with the receiver opening. In some examples, the interface body, the receiver opening or a combination of both may include a chamfer or fillet to facilitate alignment and insertion of the attachment mechanism 108 into the receiver opening.

In some examples, the interface body may include a non-circular shape to resist rotation of the attachment mechanism 108 within the receiver mechanism 114 when the attachment mechanism 108 is connected to the receiver mechanism 114. For example, the interface body and the receiver opening may have stadium shapes (i.e., a rectangle with rounded ends). In other examples, the interface body and the receiver opening may have other non-circular shapes (e.g., oval, rectangle, square, non-uniform quadrilateral, polygon, etc.) that prevent rotation of the stylus device 102 when the attachment mechanism 108 is inserted into the receiver opening.

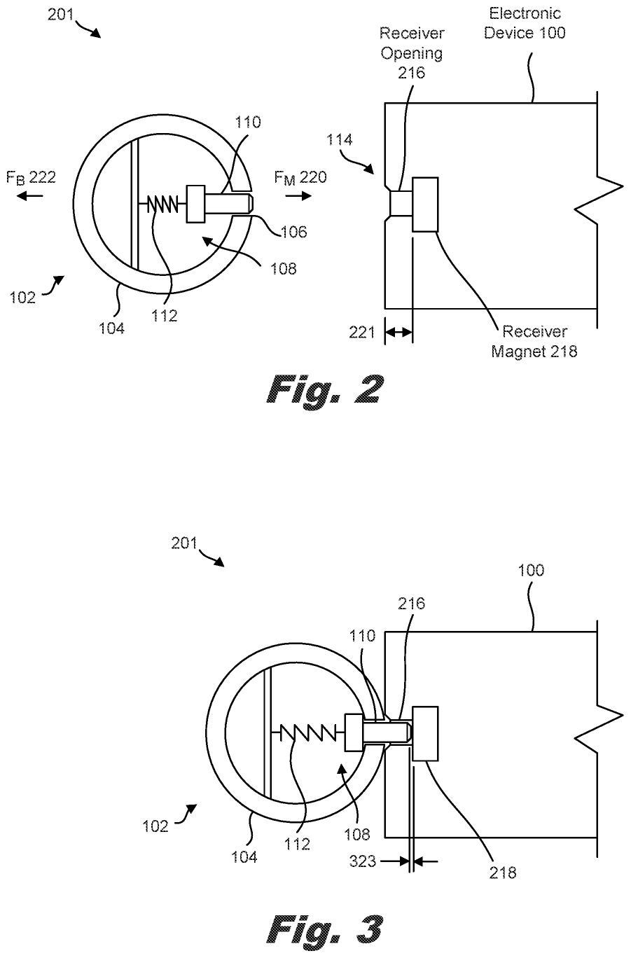

In some examples, the attachment mechanism 108 may include a bias mechanism 112 to retract the attachment mechanism 108 (or a portion of the attachment mechanism 108) into the body portion 104. For example, the bias mechanism 112 may retract the magnet 110 or the interface body of the attachment mechanism 108 into the body portion 104. As used herein a bias mechanism is a device that exerts a force on the attachment mechanism 108. In some examples, the force of the bias mechanism 112 may be oriented to cause the attachment mechanism 108 to retract into the body portion 104, as illustrated in FIG. 2 and FIG. 3.

Referring momentarily to FIG. 2, an example of a system 201 that includes the stylus device 102 and the electronic device 100 is depicted. As described above, the stylus device 102 may include a magnet 110 to extend out of the stylus device 102 in response to a magnetic force (F_{M}) 220. The stylus device 102 may also include a bias mechanism 112 to retract the magnet 110 into the stylus device 102 when a bias mechanism force (F_{B}) 222 is greater than the magnetic force (F_{M}) 220 applied to the magnet 110.

In FIG. 2, the attachment mechanism 108 is shown in a retracted position. In this case, the bias mechanism 112 exerts a bias mechanism force (F_{B}) 222 to pull the attachment mechanism 108 into the body portion 104.

Also depicted in FIG. 2 is the receiver mechanism 114 of the electronic device 100. In this example, the receiver mechanism 114 includes a receiver opening 216 to receive the magnet 110 of the stylus device 102. The receiver mechanism 114 also includes a receiver magnet 218 to apply a magnetic force (F_{M}) 220 to the magnet 110 of the stylus device 102. In some examples, the receiver magnet 218 may be positioned at a distance 221 from an exterior surface of the electronic device 100. For example, the distance 221 may allow the attachment mechanism 108 to be inserted through the receiver opening 216 a certain amount. For example, the distance 221 may define a cavity in the receiver mechanism 114 into which the attachment mechanism 108 may be inserted. In some examples, the distance 221 may be sized to allow the magnet 110 of the stylus device 102 to be fully inserted into the receiver mechanism 114 when the magnet is in an extended position.

The receiver magnet 218 may interact with the magnet 110 of the attachment mechanism 108 to create the magnetic force (F_{M}) 220 on the attachment mechanism 108. As the distance between the magnet 110 and the receiver magnet 218 decreases, the magnetic force (F_{M}) 220 increases. Furthermore, as the distance between the magnet 110 and the receiver magnet 218 increases, the magnetic force (F_{M}) 220 decreases. The attachment mechanism 108 may move when the magnetic force (F_{M}) 220 exceeds the bias mechanism force (F_{B}) 222. In the example of FIG. 2, the stylus device 102 is removed from the electronic device 100. In this case, the bias mechanism force (F_{B}) 222 is greater than the magnetic force (F_{M}) 220. Therefore, the attachment mechanism 108 remains retracted in the body portion 104 of the stylus device 102.

Referring now to FIG. 3, stylus device 102 is located near the receiver mechanism 114. In this case, the magnetic force (F_{M}) 220 is greater than the bias mechanism force (F_{B}) 222, and the attachment mechanism 108 moves out of the body portion 104 of the stylus device 102. When in the extended position, the attachment mechanism 108 may be inserted into the receiver opening 216 of the receiver mechanism 114.

In some examples, the receiver magnet 218 may contact the magnet 110 of the attachment mechanism 108 when the attachment mechanism 108 is inserted in the receiver opening 216. In some examples, a gap 323 may exist between the receiver magnet 218 and the magnet 110. Because the magnet 110 is restricted from extending out of the body portion 104 beyond a certain amount, the amount of gap 323 may be used to control the maximum magnetic force (F_{M}) 220 that can be exerted on the magnet 110 by the receiver magnet 218. For example, a larger gap 323 will result in a weaker maximum magnetic force (F_{M}) 220, while a smaller gap 323 will result in a stronger maximum magnetic force (F_{M}) 220. In this example, the gap 323 may be reduced or eliminated to allow the receiver magnet 218 to contact the magnet 110 of the attachment mechanism 108. In some examples, the gap 323 may be used to ensure that the magnetic force (F_{M}) 220 remains more than the bias mechanism force (F_{B}) 222 when the attachment mechanism 108 is inserted in the receiver opening 216.

The magnetic force (F_{M}) 220 of the receiver magnet 218 may hold the attachment mechanism 108 in the receiver opening 216 of the electronic device 100. Furthermore, the physical interaction of the attachment mechanism 108 on the sides of the receiver opening 216 may resist detachment of the stylus device 102 from the electronic device 100. For example, the physical interaction of the attachment mechanism 108 on the sides of the receiver opening 216 may allow the stylus device 102 to be removed along the travel axis that the attachment mechanism 108 travels within the receiver opening 216. Forces exerted on the stylus device 102 that are out of alignment with the travel axis may be resisted. Therefore, a lateral bump on the stylus device 102 may not be sufficient to detach the stylus device 102 from the electronic device 100.

In some examples, the magnetic force (F_{M}) 220 applied by the receiver magnet 218 may cause the magnet 110 to extend out of the stylus device 102 before the magnet 110 enters the receiver opening 216 of the electronic device 100. For example, as the stylus device 102 is brought near the receiver mechanism 114, the magnet 110 may begin to interact with the magnetic field of the receiver magnet 218. At a certain point before the stylus device 102 contacts the electronic device 100, the magnetic force (F_{M}) 220 may overcome the bias mechanism force (F_{B}) 222, which results in the attachment mechanism 108 extending out of the stylus device 102. Thus, the attachment mechanism 108 may automatically slide out of the stylus device 102 to engage with the electronic device 100. With the attachment mechanism 108 extended, a user may easily align the attachment mechanism 108 with the receiver opening 216.

In some examples, the bias mechanism 112 may retract the magnet 110 into the stylus device 102 when the magnet 110 is located at a distance greater than or equal to a threshold distance from the receiver opening 216 of the electronic device 100. For example, once the stylus device 102 is removed from the receiver opening 216 of the electronic device 100, the attachment mechanism 108 may remain extended out of the stylus device 102 until the bias mechanism force (F_{B}) 222 is greater than the magnetic force (F_{M}) 220. At this point, the bias mechanism force (F_{B}) 222 may force the attachment mechanism 108 back into stylus device 102. The threshold distance may be based on the material of the magnets used, the amount of bias mechanism force (F_{B}) 222 exerted by the bias mechanism 112, and the distance the receiver magnet 218 is located from the exterior surface of the electronic device 100.

Referring again to FIG. 1, in some examples, the bias mechanism 112 may be implemented as a single spring or multiple springs that exert a force to retract the attachment mechanism 108. In some examples, the bias mechanism 112 may be a stamp spring that is fabricated by stamping a sheet material (e.g., metal). In other examples, the bias mechanism 112 may be a coil spring, leaf spring, compression spring, extension spring, torsion spring, or other type of spring. In some examples, the bias mechanism 112 may be an elastomeric material that applies a force to retract the attachment mechanism 108 in response to compression or extension of the elastomeric material.

In some examples, the attachment mechanism 108 and receiver mechanism 114 may facilitate charging and communications between the stylus device 102 and the electronic device 100. In some examples, the receiver mechanism 114 may include a charging port to charge the stylus device 102. In this example, the attachment mechanism 108 may conduct an electrical current and voltage from the electronic device 100 to charge a battery of the stylus device 102 when connected to the receiver mechanism 114. In another example, the receiver mechanism 114 may include an input/output (I/O) port for communicating with the stylus device 102. In this example, signals between the stylus device 102 and the electronic device 100 may be sent over the I/O port when the attachment mechanism 108 is connected to the receiver mechanism 114.

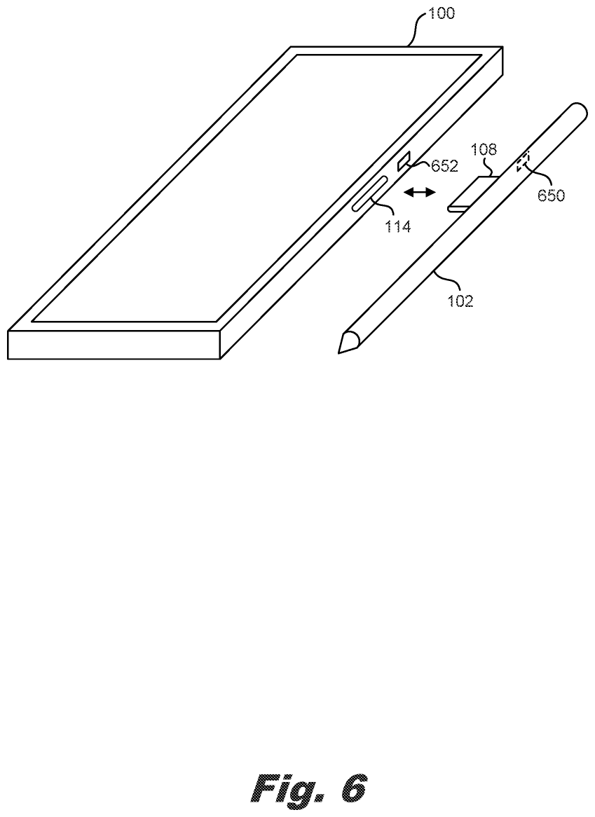

In another example, the attachment mechanism 108 and receiver mechanism 114 connection may align the stylus device 102 with a port (e.g., charging port, I/O port) of the electronic device 100 that is outside the receiver mechanism 114. An example where the attachment mechanism 108 aligns ports of the stylus device 102 and the electronic device 100 is described in FIG. 6.

The examples described herein may increase the attachment forces applied to the stylus device 102 to withstand removal of the stylus device 102 from the receiver mechanism 114. The examples also resist detachment of the stylus device 102 due to accidental loads or bumps. For example, the described attachment mechanism 108 may reduce the likelihood that the stylus device 102 will detach from the electronic device 100 when placed in a backpack or other container. Additionally, because the attachment mechanism 108 is hidden in the body portion 104 of the stylus device 102 when being held by a user, there is minimal impact to the cosmetic appearance and tactile feel of the stylus device 102. Furthermore, the attachment mechanism 108 provides a physical interface between the stylus device 102 and the electronic device 100, which may ease placement of the stylus device 102 on the electronic device 100 by a user.

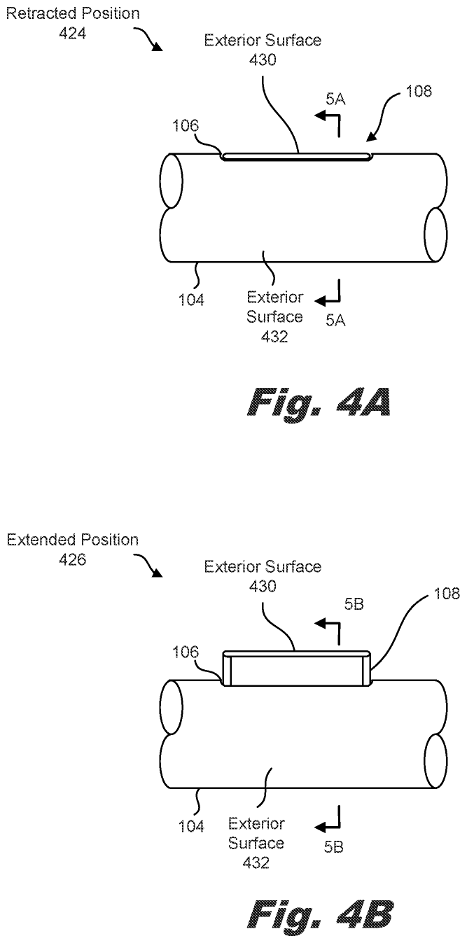

FIGS. 4A and 4B illustrate examples of the stylus device 102. FIG. 4A illustrates the attachment mechanism 108 in a retracted position 424. For example, a bias mechanism may force the attachment mechanism 108 into the body portion 104. In this case, the exterior surface 430 of the attachment mechanism 108 is aligned with an exterior surface 432 of the body portion 104 when the attachment mechanism 108 is retracted into the body portion 104 through the opening 106. In other words, the exterior surface 430 of the attachment mechanism 108 may be flush with the exterior surface 432 of the body portion 104.

FIG. 4B illustrates the attachment mechanism 108 in an extended position 426. For example, a magnet of the attachment mechanism 108 may force the attachment mechanism 108 to extend out of the body portion 104 through the opening 106.

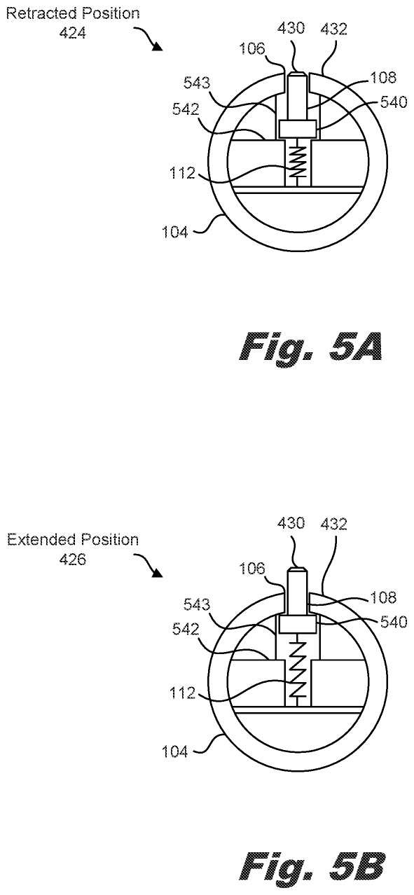

FIGS. 5A and 5B are section views of the example stylus device 102 illustrated in FIGS. 4A and 4B, respectively. In FIG. 5A, the attachment mechanism 108 is in a retracted position 424. In this case, the attachment mechanism 108 is forced into a cavity formed by the opening 106 of the body portion 104. The exterior surface 430 of the attachment mechanism 108 is aligned with the exterior surface 432 of the body portion 104.

In some examples, the attachment mechanism 108 includes a motion arresting element 540. In some examples, the motion arresting element 540 may stop the attachment mechanism 108 at the retracted position 424. In some examples, the motion arresting element 540 may be a protrusion, bumper or other mechanism attached to or formed on the attachment mechanism 108. In some examples, the motion arresting element 540 may contact an alignment element 542. In some examples, the alignment element 542 may be attached to or formed on the body portion 104. The alignment element 542 may contact the motion arresting element 540 of the attachment mechanism 108 to stop the attachment mechanism 108 at the retracted position 424.

In some examples, the interior cavity of the body portion 104 may include a channel 543 to constrain the motion of the attachment mechanism 108. For example, the channel 543 may include walls oriented in the travel axis of the attachment mechanism 108. The motion arresting element 540 attachment mechanism 108 may move along the channel 543, which may limit rotation of the attachment mechanism 108 within the cavity of the body portion 104.

In FIG. 5B, the attachment mechanism 108 is in an extended position 426. For example, attachment mechanism 108 may extend through the opening 106 in the sidewall of the body portion 104. In this case, a magnet of the attachment mechanism 108 may exert a force to move the attachment mechanism 108 to the extended position 426. In some examples, the motion arresting element 540 may contact the body portion 104 or a component attached to the body portion 104 to keep the attachment mechanism 108 from moving beyond the extended position 426.

It should be noted that when the attachment mechanism 108 is in the extended position 426, the bias mechanism 112 may exert a force that would cause the attachment mechanism 108 to retract back within the body portion 104 when the bias mechanism force is greater than the magnetic force.

FIG. 6 illustrates the attachment mechanism 108 aligning a port 650 of the stylus device 102 with a port 652 of the electronic device 100, according to an example. In this example, the electronic device 100 may include a port 652 located adjacent to the receiver opening of the receiver mechanism 114. The stylus device 102 may also include a corresponding port 650 on the exterior surface of the body portion of the stylus device 102. In some examples, the ports 650, 652 may be used for charging, for I/O communication, or for a combination of both.

When the attachment mechanism 108 is inserted into the receiver mechanism 114, the port 650 of the stylus device 102 may be aligned to contact the port 652 of the electronic device 100. Once the attachment mechanism 108 is inserted into the receiver mechanism 114 and the ports 650, 652 connect, charging or communications between the stylus device 102 and the electronic device 100 may occur.

It should be noted that examples described may include various components and features. It should also be noted that numerous specific details are set forth to provide a thorough understanding of the examples. However, it should be noted that the examples may be practiced without limitations to these specific details. In other instances, methods and structures may not be described in detail to avoid unnecessarily obscuring the description of the examples. Also, the examples may be used in combination with each other.

1. A stylus device, comprising:
a body portion having an opening; and
an attachment mechanism to connect the stylus device to a receiver mechanism, the attachment mechanism comprising:
a magnet to cause the attachment mechanism to extend through the opening in response to a magnetic force, wherein the magnet comprises a motion arresting element to prevent the attachment mechanism from detaching from the stylus device; and
a bias mechanism to retract the attachment mechanism into the body portion.

2. The stylus device of claim 1, wherein the magnetic force is to be generated through interaction of the magnet and a receiver magnet of the receiver mechanism.

3. The stylus device of claim 1, wherein the attachment mechanism is to move when the magnetic force exceeds a bias mechanism force.

4. The stylus device of claim 1, wherein the attachment mechanism further comprises an interface body to extend and retract through the opening of the body portion.

5. The stylus device of claim 4, wherein the magnet forms the interface body.

6. The stylus device of claim 4, wherein the interface body comprises a non-circular shape to resist rotation of the attachment mechanism within the receiver mechanism when connected to the receiver mechanism.

7. The stylus device of claim 1, wherein an exterior surface of the attachment mechanism is to be aligned with an exterior surface of the body portion when the attachment mechanism is retracted into the body portion.

8. The stylus device of claim 7, wherein the exterior surface of the attachment mechanism is to extend beyond the exterior surface of the body portion when the attachment mechanism extends through the body portion.

9. An electronic device comprising:
a receiver opening to receive an attachment mechanism of a stylus device; and
a receiver magnet to apply a magnetic force to a magnet of the attachment mechanism, the receiver magnet to cause the attachment mechanism to extend through an opening in the stylus device, wherein the magnet of the attachment mechanism comprises a motion arresting element to prevent the attachment mechanism from detaching from the stylus device.

10. The electronic device of claim 9, wherein the magnetic force of the receiver magnet is to hold the attachment mechanism in the receiver opening.

11. The electronic device of claim 10, wherein the receiver opening comprises a stadium shape.

12. The electronic device of claim 9, wherein the receiver magnet is to be positioned at a distance from an exterior surface of the electronic device, and wherein the receiver magnet is to contact the magnet of the attachment mechanism when the attachment mechanism is inserted in the receiver opening.

13. A system comprising:
a stylus device comprising:
a magnet to extend out of the stylus device in response to a magnetic force, wherein the magnet comprises a motion arresting element to prevent the attachment mechanism from detaching from the stylus device; and
a bias mechanism to retract the magnet into the stylus device when a bias mechanism force is greater than the magnetic force; and
an electronic device comprising:
a receiver opening to receive the magnet of the stylus device; and
a receiver magnet to apply the magnetic force to the magnet of the stylus device.

14. The system of claim 13, wherein the magnetic force applied by the receiver magnet is to cause the magnet to extend out of the stylus device before the magnet enters the receiver opening of the electronic device.

15. The system of claim 13, wherein the bias mechanism is to retract the magnet into the stylus device when the magnet is located at a distance greater than or equal to a threshold distance from the receiver opening of the electronic device.

16. The stylus device of claim 1, wherein the magnet is formed with projections that prevent the attachment mechanism from exiting the stylus device when the attachment mechanism is extended.

17. The stylus device of claim 1, wherein the magnet is exposed to contact a receiver magnet of the receiver mechanism when the attachment mechanism connects to the receiver mechanism.

18. The stylus device of claim 1, wherein the motion arresting element to maintain a gap between the magnet and a receiver magnet of the receiver mechanism when the attachment mechanism connects to the receiver mechanism, the gap to ensure that the magnetic force remains greater than a bias mechanism force when the attachment mechanism is inserted in the receiver mechanism.

19. stylus device of claim 1, further comprising an port located on the body portion, wherein the attachment mechanism to align the port of the stylus device with a port of an electronic device that is outside the receiver mechanism.

20. The stylus device of claim 1, further comprising a battery, wherein the attachment mechanism is to conduct an electrical current and voltage from an electronic device to charge the battery of the stylus device when connected to the receiver mechanism.
